(19) United States
(12) Patent Application Publication
(10) Pub. No.: US 2003/0001845 A1
(43) Pub. Date: Jan. 2, 2003

(54) Black line insertion for overly tall liquid crystal imagers

(76) Inventor: Donald Henry Willis, Indianapolis, MN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/099,009

(22) Filed: Mar. 14, 2002

Related U.S. Application Data
(60) Provisional application No. 60/290,538, filed on May 11, 2001.

(51) Int. Cl. G09G 5/00

(52) U.S. Cl. 345/443

(57) ABSTRACT

A system (10) and method (500) of black line insertion for overly tall imagers having random row access includes the step (502) of periodically writing in a predetermined number of input video lines into a memory (12) and the step (504) of speeding up the reading of the predetermined number of input video lines out from the memory to provide a time enhancement. The method further includes the step (506) of multiplexing (14) a black input line with the sped-up predetermined number of input video lines during the time enhancement to provide an output image. The method can include the step (508) of presenting on the overly tall imager (16) the output image using the random row access to place the lines in the correct vertical position.

### CROSS REFERENCE TO RELATED APPLICATIONS

This is a non-provisional application of provisional application Serial No. 60/290,538 filed May 11, 2001.

### BACKGROUND OF THE INVENTION

1. Field of the Invention

This invention relates to the field of projection television receivers and displays in general, and in particular, to projection television receivers and displays utilizing imagers having random row access, for example liquid crystal on silicon (LCOS) imagers.

2. Description of Related Art

Liquid crystal imagers, for example LCOS imagers, are often made with more rows than are wanted for a given application. The nature of a liquid crystal imager, particularly a normally white LCOS imager, is that used pixels cannot simply be left blank or empty, but must be driven to the blackest black level possible. It is necessary to write these unwanted rows with a black level as well as write the desired rows with video in order to avoid degradation of the imager. This might be necessary when a picture having a wide screen aspect ratio of 16:9 is displayed using an imager having an aspect ratio of 4:3.

Inserting black rows is usually done by writing all the black rows needed at the top of the picture, followed by writing the desired video rows, followed by writing more black rows at the bottom of the picture. The desired rows are thus written in a shorter time period than they are formed by the incoming signal after it is processed by the formatting circuits. As a result, at least a partial field memory must be used to speed up the desired signal so that there is time to write the black rows. This requires substantial extra memory capacity and memory bandwidth to perform this function.

There is always a need in developing video display systems to reduce memory requirements and bandwidth, so that circuits can be simplified and costs can be reduced.

### SUMMARY OF THE INVENTION

Extra rows of an LCOS imager can be written with black in accordance with the inventive arrangements by utilizing an imager with random row access and by speeding up the writing of desired image rows with a line memory and using the time remaining to write the black rows. The rows can be written by writing a black row for every one, two, or three, etc. image rows. The inventive arrangements make it possible to populate the unused rows of the imager at the black level and the active rows of the imager within the same time interval needed to display each field without the use of an unnecessarily large memory.

In a first aspect of the present invention, an black line insertion system for an imager having random row access comprises a speedup line memory for reading out from the memory a plurality of horizontal lines as an output signal at a speed being a predetermined proportion faster than the speed the plurality of horizontal lines are written into the memory, whereby a proportionate time enhancement (further described below) is achieved and means for inserting a black line into the output signal during the proportionate time enhancement of the speedup line memory to provide a modified output signal. The system can include a means for presenting the modified output signal.

In a second aspect of the present invention, a method of modifying an input video signal to accommodate an overly tall imager comprising the steps of increasing the horizontal frequency of a modified output signal by a predetermined ratio, multiplexing an output signal with a black line input signal to provide the modified output signal, wherein the predetermined ratio determines a periodicity of the multiplexed black line input signal, and presenting the modified output signal on the overly tall imager.

In a third aspect of the present invention, a method of modifying an input video signal to accommodate an overly tall imager comprises the steps of reading out from memory a plurality of horizontal lines as an output signal at a speed being a predetermined proportion faster than the speed the plurality of horizontal lines are written into the memory, whereby a proportionate time enhancement is achieved and periodically multiplexing a black line input signal with the output signal during at least a portion of the proportionate time enhancement to provide a modified output signal. The method can also include the step of presenting the modified output signal on the overly tall imager.

In a fourth aspect of the present invention, a method of black line insertion for overly tall imagers having random row access comprises the steps of periodically writing in a predetermined number of input video lines into a memory, speeding up the reading of the predetermined number of input video lines out from said memory to provide a time enhancement. and multiplexing a black input line with the sped-up predetermined number of input video lines during the time enhancement to provide an output image. The method in accordance with this embodiment can further include the step of presenting the output image on the overly tall imager.

### BRIEF DESCRIPTION OF THE DRAWINGS

FIG. 1 is a block diagram of a video processing circuit in accordance with the inventive arrangements.

FIG. 2 is a timing diagram useful for explaining the inventive arrangements and the operation of the block diagram in FIG. 1.

FIG. 3 is a flow chart illustrating a method in accordance with the present invention.

FIG. 4 is a flow chart illustrating another method in accordance with the present invention.

FIG. 5 is a flow chart illustrating yet another method in accordance with the present invention.

### DETAILED DESCRIPTION OF THE PREFERRED EMBODIMENTS

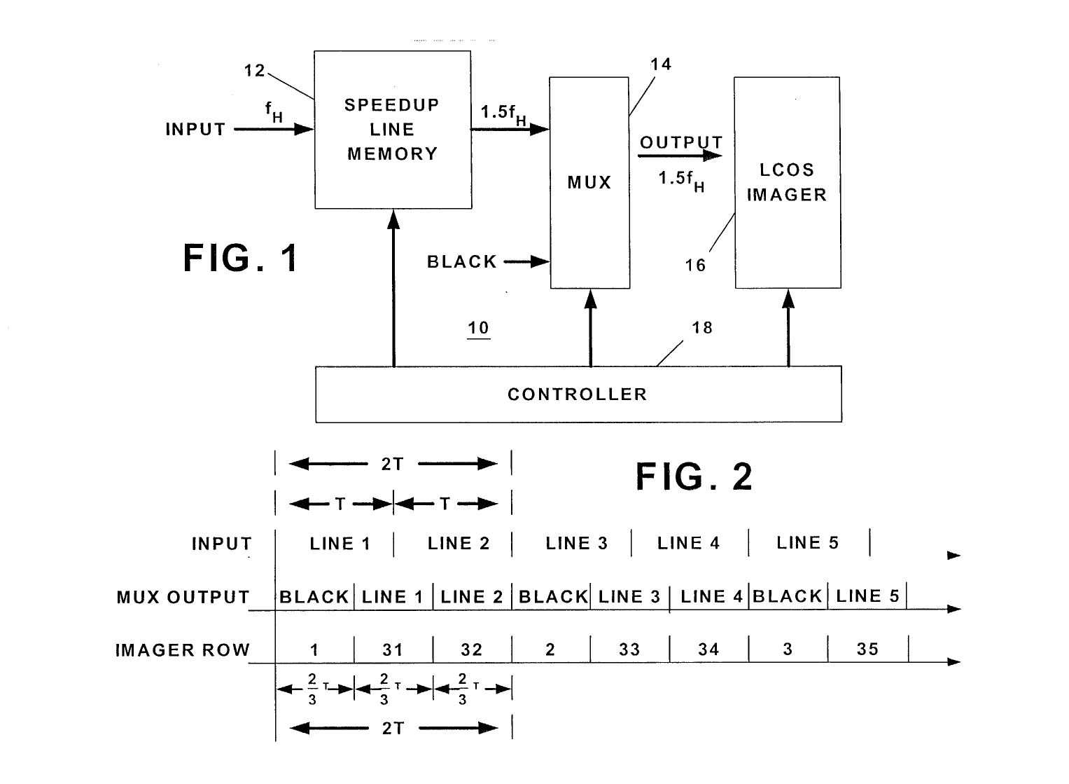

With reference to the video display system 10 shown in FIG. 1, the input video is written into a speedup line memory 12. If the speedup factor is 1.5, and the input has a horizontal scanning frequency of f_{H}, for example, the output lines will have a period, for example, of 1/1.5 f_{H}. After ⅔rds of a line is written, the line memory starts to be read out as a first input to a multiplexer 14. The multiplexer selects the reading output of the line memory to be displayed. The multiplexer has a black pixel level as a second input. A controller 18 selects the proper row in the display or imager for the line to be written to the display. The reading speed (reading out of the line memory), as noted, is faster than the writing speed (into the line memory).

After reading out or displaying two lines in this manner, using four-thirds of a line period when a 1.5 speedup factor is employed, the controller instructs the display to write a black row. This black row is displayed for another ⅔ of an input line period. This cycle then repeats, allowing up to one-third of the lines written to be black-insertion lines at the top and bottom of the picture.

A timing diagram in FIG. 2 shows the sequence. As line 1 is written into the line memory, a first black line is supplied to row 1 of the imager. Image lines 1 and 2 are supplied to the imager, each in ⅔ of an input line period. Three image lines (two image lines and one black line) are supplied to three rows of the imager in the time it would otherwise take two image lines to be written into the line memory. In a similar fashion, a second black line and image lines 3 and 4, are supplied to the image in the same time period needed to write two lines into the memory. The cycle repeats until the imager is fully loaded with picture data and black lines.

As an alternative, it is possible to write the black rows alternately to the top and bottom of the imager, rather than filling in the top black bar entirely before filling in the lower black bar. It should also be understood within contemplation of the present invention that the black lines could be inserted all on the top or all on the bottom or in a proportion divided between the top and bottom as desired using a random row access imager.

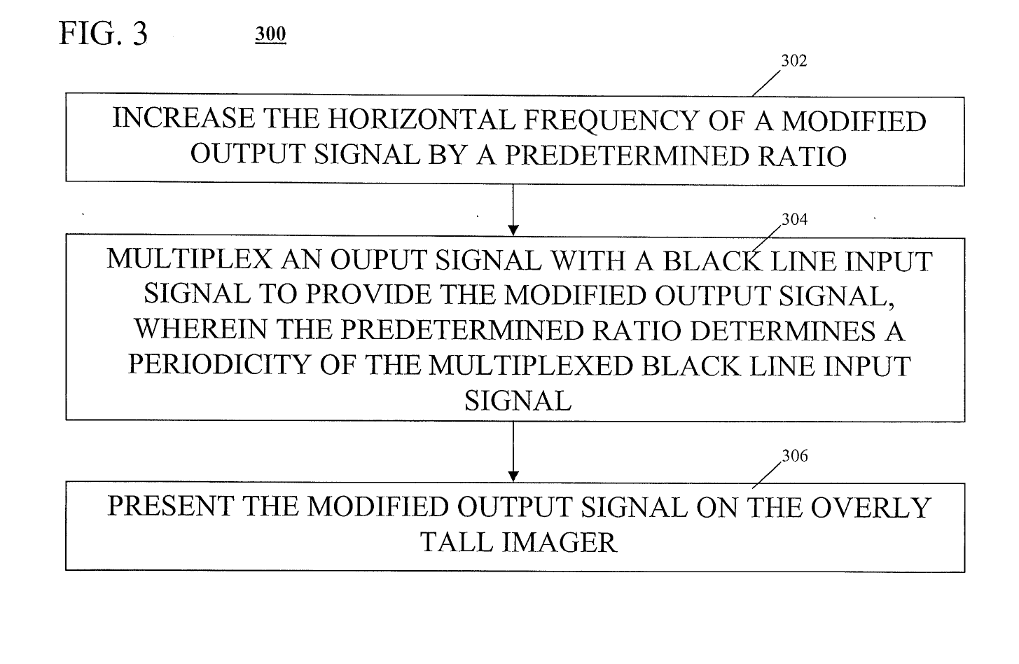

Referring to FIG. 3, a flow chart illustrating a method 300 of modifying an input video signal to accommodate an overly tall imager is shown. Method 300 preferably comprises the step 302 of increasing the horizontal frequency of an output signal by a predetermined ratio, periodically multiplexing at step 304 the output signal with a black line input signal to provide a modified output signal, wherein the predetermined ratio determines a periodicity of the multiplexed black line input signal. The method further comprises the step 306 of presenting the modified output signal on the overly tall imager.

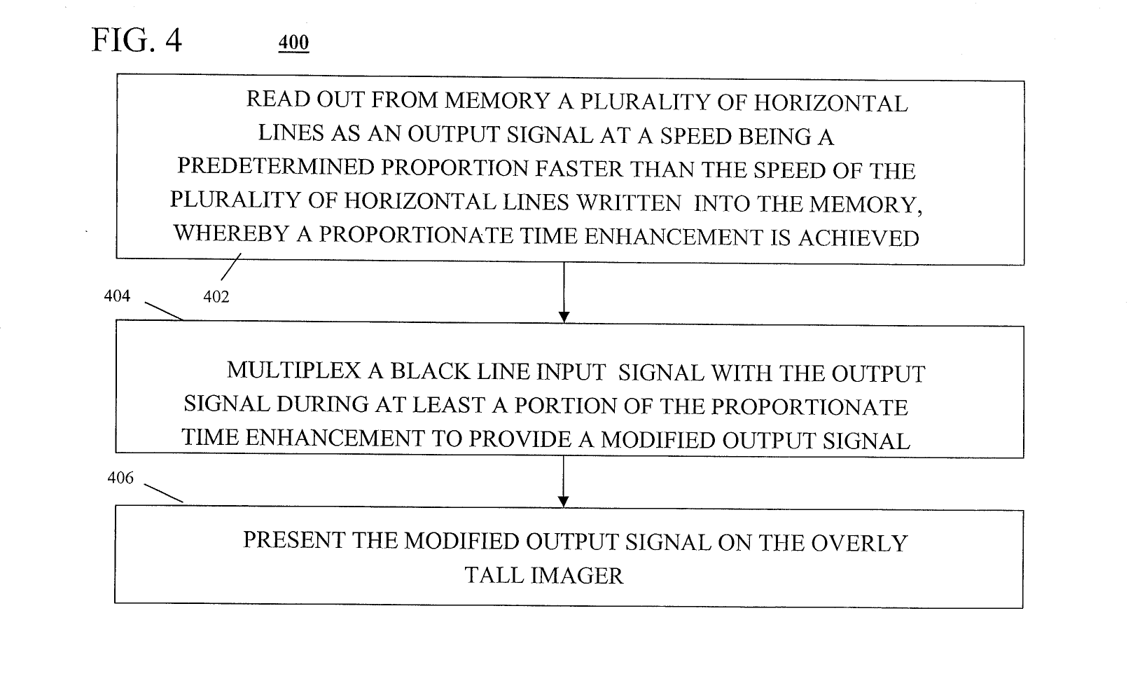

Referring to FIG. 4, a flow chart illustrating a method 400 of modifying an input video signal to accommodate an overly tall imager is shown. The method 400 preferably comprises the step 402 of reading out from memory a plurality of horizontal lines as an output signal at a speed being a predetermined proportion faster than the speed the plurality of horizontal lines are written into the memory, whereby a proportionate time enhancement is achieved. The time enhancement is evident in FIG. 2 by the shortening of time occupied by the first two lines at the output versus the time occupied by the first two lines at the input. At step 404, a black line input signal is periodically multiplexed with the output signal during at least a portion of the proportionate time enhancement to provide a modified output signal. If the predetermined proportion is 3 to 2 for example, then up to a third of a total number of horizontal lines of the overly tall imager can be filled with black lines. At step 406, the modified output signal can then be presented or displayed on the overly tall imager.

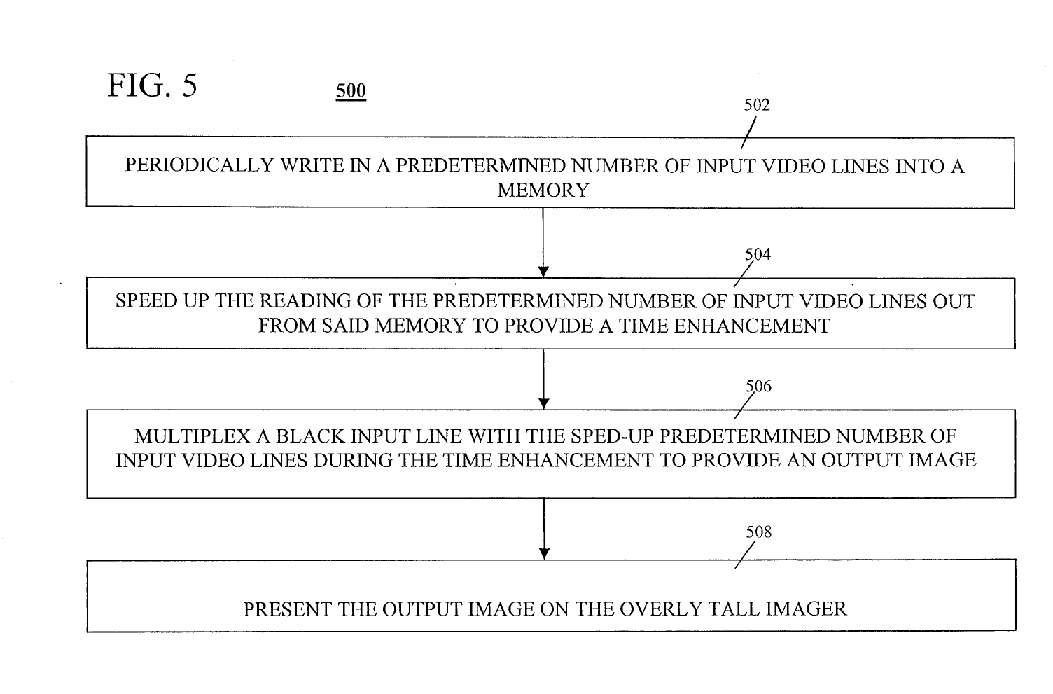

Referring to FIG. 5, a flow chart illustrating yet another method 500 of black line insertion for overly tall imagers having random row access is shown. The method 500 preferably comprises the step 502 of periodically writing in a predetermined number of input video lines into a memory and the step 504 of speeding up the reading of the predetermined number of input video lines out from to memory to provide a time enhancement. The method further comprises the step 506 of multiplexing a black input line with said sped-up predetermined number of input video lines during the time enhancement to provide an output image. Preferably, the step of speeding up includes a speedup factor that will result in an output line period that is inversely proportional to the number of lines in the overly tall imager. Finally, the method can include the step 508 of presenting on the overly tall imager the output image using the random row access of the imager to place the lines in the correct vertical position.

Although the present invention has been described in conjunction with the embodiments disclosed herein, it should be understood that the foregoing description is intended to illustrate and not limit the scope of the invention as defined by the claims.

What is claimed is:

1. A black line insertion system for an imager having random row access, comprising:
a speedup line memory for reading out from said memory a plurality of horizontal lines as an output signal at a speed being a predetermined proportion faster than the speed the plurality of horizontal lines are written into the memory, whereby a proportionate time enhancement is achieved;
means for inserting a black line into the output signal during the proportionate time enhancement of the speedup line memory to provide a modified output signal; and
means for presenting the modified output signal.

2. The system of claim 1, wherein the means for inserting comprises a black line input signal multiplexed with the output signal using a multiplexer, wherein the multiplexer and speedup line memory are controlled by a controller programmed to insert black lines during the proportionate time enhancement.

3. The system of claim 1, wherein the means for presenting is selected from a group of imagers including liquid crystal on silicon (LCOS), plasma, micromirrors, liquid crystal display, and transmissive liquid crystal display projection.

4. The system of claim 1, wherein the means for inserting black lines inserts black lines on a top portion of the imager to form an upper black bar and then inserts black lines on a bottom portion of the imager to form a lower black bar.

5. The system of claim 1, wherein the means for inserting black lines inserts black lines on a top portion of the imager and then inserts black lines on a bottom portion of the imager in an alternating manner to form an upper black bar and a lower black bar.

6. A method of modifying an input video signal to accommodate an overly tall imager, comprising the steps of:
increasing the horizontal frequency of a modified output signal by a predetermined ratio;
multiplexing an output signal with a black line input signal to provide the modified output signal, wherein the predetermined ratio determines a periodicity of the multiplexed black line input signal; and
presenting the modified output signal on the overly tall imager.

7. A method of modifying an input video signal to accommodate an overly tall imager, comprising the steps of:
reading out from memory a plurality of horizontal lines as a modified output signal at a speed being a predetermined proportion faster than the speed the plurality of horizontal lines are written into the memory, whereby a proportionate time enhancement is achieved;
multiplexing a black line input signal with an output signal during at least a portion of the proportionate time enhancement to provide the modified output signal; and
presenting the modified output signal on the overly tall imager.

8. The method of claim 7, wherein the predetermined proportion is 3 to 2 and wherein up to a third of a total number of horizontal lines of the overly tall imager can be filled with black lines.

9. A method of black line insertion for overly tall imagers having random row access, comprising the steps of:
periodically writing in a predetermined number of input video lines into a memory;
speeding up the reading of the predetermined number of input video lines out from said memory to provide a time enhancement;
multiplexing a black input line with said sped-up predetermined number of input video lines during the time enhancement to provide an output image.

10. The method of claim 9, wherein the step of speeding up includes a speedup factor that will result in an output line period that is inversely proportional to the number of lines in the overly tall imager.

11. The method of claim 9, wherein the method further comprises the step of presenting on the overly tall imager the output image.

12. The method of claim 10, wherein responsive to the speedup factor, a black line is written to the output image line for each predetermined number of input video lines written to the output image.
